(19) United States
(12) Patent Application Publication
(10) Pub. No.: US 2008/0142447 A1
(43) Pub. Date: Jun. 19, 2008

(54) METHOD OF TREATING WASTEWATER

(76) Inventors: David Brian MITCHELL, Yardley, PA (US); Gary Engstrom, St. Louis, MO (US)

Correspondence Address: THE BOC GROUP, INC., 575 MOUNTAIN AVENUE, MURRAY HILL, NJ, 07974-2064, US

(21) Appl. No.: 11/940,359

(22) Filed: Nov. 15, 2007

Related U.S. Application Data
(60) Provisional application No. 60/859,879, filed on Nov. 17, 2006.

(51) Int. Cl. C02F 1/52; B01J 21/16

(52) U.S. Cl. 210/665; 502/80; 502/84

(57) ABSTRACT

Processes for the treatment of wastewater comprising incorporating a delaminated nanoparticulate clay into a treatment mixture to form a coagulant. The nanoparticulate clay comprises an anionic coagulant. Preferred nanoparticulate clays are bentonite clays and hectorite clays.

### FIELD OF THE INVENTION

The present invention relates to a process for treating wastewater, particularly to a process for treating wastewater using nanoparticles of clay.

### BACKGROUND OF THE INVENTION

Nanotechnology is an extremely broad technology area including and coordinating many disciplines, with the potential for application in a broad range of environmental products, in addition to applications being researched in the biomedical, electronics, sensors, and other industries.

Nanoscale research is important in many environmental areas, including molecular studies of mineral surfaces, the transportation of ultrafine colloidal particles and aerosols. By using nanoscale research, it is expected that a benefits will be gained, including better understanding of molecular processes in the environment, development of manufacturing processes that reduce pollution, creation of new water purification techniques, improved processes for the composition of artificial photosynthetic processes for clean energy, development of environmental biotechnology, and fuller understanding of the role of surface microbiota in regulating chemical exchanges between mineral surfaces and water or air.

The integration of nanotechnology into a biological plant may allow both nanoparticle adsorption and enhanced microbial degradation to take place on the nanoparticle surface and enable the recycling of the nanoparticles. In the wastewater treatment industry, important benefits of the use of nanotechnology concepts include the movement of the boundary between the efficacy of physical primary treatment and biological treatments required in the 20^{th} and early 21^{st} centuries. For example, it may be possible to develop nanotechnological advances that remove contaminants by charge, complexation or adsorption, that conventional polymer chemistry cannot remove and that currently require the design, capital expenditure and installation of a secondary biological treatment plant.

Polymeric nanoparticle conjugates of 5-20 nm in size are comprised of polyethylene glycol or dendrimer polymers forming monodispersed, symmetric, globular shaped macromolecules comprising a series of branches around an inner core. Nanoporous membranes are currently available in the form of reverse osmosis (RO) and nanofiltration (NF) membranes. However, bacteria, such as E-coli, can impact the transportation of solutes and nutrients across the membrane by opening and closing channels (porins) in the outer membrane in response to bulk pH changes.

In the food industry renderers do not normally encounter problems with the natural silicate chemistry as opposed to issues that arise when using cationic coagulants. The renderers do not use dissolved air floatation (DAF) float technology that has been treated with ferric coagulants because of the combustion hazard that arises. In addition, DAF float systems using conventional aluminum coagulants are commonly rejected by renderers because the aluminum ions slow down the rendering process; e.g. drying and centrifugation.

Therefore, there is a need in the art for improvements in the treatment of wastewater and methods of using nanoparticles in the treatment of wastewater, particularly with respect to the food industry.

### SUMMARY OF THE INVENTION

The present invention is directed to a process for treating wastewater comprising incorporating a delaminated nanoparticulate clay into a treatment mixture to form a coagulant. The nanoparticulate clay comprises an anionic coagulant. In one embodiment, the nanoparticulate clay is a bentonite clay. In another embodiment, the nanoparticulate clay is a hectorite clay. The present provides for a blend of nanoparticles that operate via a different mechanism than current industrial techniques and therefore allow for the elimination or the reduction in size of secondary biological treatments.

### DETAILED DESCRIPTION OF PREFERRED EMBODIMENTS

The present invention combines processes of coagulation and adsorption to accomplish the removal of cationic, anionic and nonionic contaminants. By using natural products, such as clay, the present invention is applicable for use in the food industry application.

The present invention is based in part on the modification of the surface of nanoparticles in order to be useful for specific applications. The present invention shows that enhanced coagulation generates fewer totally suspended solids (TSS). In addition, the present invention increases shear resistance and enhances contamination release, enabling an increase in recovery of oil from dissolved air flotation (DAF) float.

Further, the present invention provides methods that reduce wastewater effluent and therefore lead to increased protein recovery and reduced toxicity. By increasing the efficacy of the physical primary treatment, the need for a secondary biological treatment can be reduced or in some cases eliminated. The nanoparticle coagulation of the present invention is not effected by chelating cleaners that are commonly used in the food industry. Therefore, the nanoparticle coagulation substantially reduces the amount of chemicals in the wastewater treatment process and thus reduces solids disposal requirements.

A preferred raw material for the nanoparticles used according to the present invention is a swellable bentonite, such as Bentolite 865. This material is delaminated via shear to form an anionic nanoparticulate coagulant. This is different than most commercially available coagulants that are either cationic or amphoteric. Therefore, the nanoparticulate coagulants of the present invention operate according to a different coagulant chemistry. In particular, the anionic nanoparticle coagulants of the present invention do not neutralize the anionic charge of the contaminants like conventional cationic coagulants, but rather provide an anionic surface for the cationic contaminants to adsorb onto and bridge the nanoparticles. This bridged nanoparticles form the traditional pin floc necessary before the flocculent addition.

The combination of anionic nanoparticle coagulant clay and contaminant bridges between the clays creates the opportunity for synergies with conventional coagulants. In particular, blends or mixtures of the anionic nanoparticle coagulant clay and conventional coagulants can be exploited to remove a broader array of contaminants than is possible when using either coagulant individually. These synergies will depend a layered adsorption onto the cationic nanoparticles of anionic contaminants.

The use of Bentolite 865 nanoparticles relies upon the presence of cationic contaminants. These may be monomenc but are preferably polymeric in nature. The nanoparticles provide a large surface area for adsorption in a cost effective manner. This is much more effective than the use of micron or larger particle sized adsorbents that can not act as coagulants because the particle size is too great for the contaminants to bridge gaps between such microparticles. In accordance with the present invention, the nanoparticulate coagulation of wastewater allows the contaminants to adsorb onto the particles create the floe of nanoparticles that in turn brings the contaminant out of solution. In particular, the nanoparticles bridged by contaminants form a standard pin floc that can then be fully flocculated with a conventional flocculent.

Table 1 shows the results of evaluation of nanoparticulate coagulants to determine 1) the effectiveness of delaminating clay particles and the optimum concentration of clay to be delaminated; 2) the impact of clay chemistry on nanoparticle performance; 3) the pH window for nanoparticles versus conventional chemistry; and 4) the effectiveness of non-delaminated clay.

In particular, Table I compares several delaminated nanoparticles, including Bentolite 865 at 20% (a delaminated high swelling bentonite), Bentolite L10 (a delaminated low swelling bentonite), EA3002 (a delaminated hectorite) and Particlear (a polymeric sodium silicate). The bentonites and hectorite were tested at 100, 150 and 200 mg/L while Particlear was tested at 150 mg/L. Mix times were all set at 60 seconds and settling times were set at 1 minute. A control of 1.5 mg/L NaOH (50%) was also included. The bentonites, hectorite and Particlear all contained 113 mg/L of NaOH (50%) and had a pH of 4.4. In addition, 10 mg/L of Superfloc 1598 was added to each of the bentonite, hectorite and Particlear samples. The clays were sheared for about 10 minutes and the temperature was controlled to less than about 155°0 F. It is noted that turbidity, COD and TSS measurements were not obtained for the Bentolite L10 samples. Further, both talc and Perlite were evaluated but were found to be completely ineffective.

The results of the evaluation show that all of the samples tested provide turbidity well below the control turbidity of 403 FAU. The EA3002 at 200 mg/L sample provides the lowest turbidity of 4 FAU, with both EA3002 at 150 mg/L and Bentolite 865 at 200 mg/L having a turbidity of 27 FAU. Total COD was measured in ppm, with again all samples coming in significantly below the control of 4300 ppm. The Bentolite 865 at 200 mg/L provided the lowest total COD of 3420 ppm, as compared to 3720 ppm for EA3002 at 150 mg/L. Soluble COD also measured in ppm showed the Bentolite 865 at 200 mg/L provided the lowest soluble COD of 3720 ppm, compared to 3690 ppm for EA3002 at 200 mg/L and 4710 ppm for the control. TSS was measured in ppm with the Bentolite 865 at 200 mg/L having a total of 80 ppm, as compared to 44 ppm for EA3002 at 150 mg/L and 194 ppm for the control.

The results show that not all bentonites worked effectively. The Bentolite 865 is a higher swelling clay and seemed to delaminate more effectively because of significantly higher viscosity than that of Bentolite L10. The superior delamination of Bentolite 865 is believed to occur because the calcium exchangeable ion exchanges with a sodium ion which weakens the attraction between the plates and thereby increases delamination.

The Bentolite 865 samples performed better than the two control samples. In particular, Particlear sample was used as a commercial control while the EA3002 sample acted as a technical control (i.e. excellent performance but too high a cost for commercial application). The Bentolite 865 samples provided excellent performance, superior to the Particlear sample as evidenced by the lower turbidities. The hectorite control EA3002, provided excellent performance but is a refined product having a cost that is two high for practical commercial use.

It is noted that it is possible to change the operating pH window of the nanoparticle by changing the nanoparticle surface chemistry. In addition, the viscosity of the delaminated clays is >5,000 cps, but can be controlled or eliminated by the addition of a suitable phosphate, such as <0.3% Tetra-Sodium Pyro Phosphate (TSPP).

Table 2 compares further delaminated nanoparticles, including Bentolite 865 at 15% (a delaminated high swelling bentonite), Bentolite 865 at 20% (a delaminated high swelling bentonite), Bentone OC at 10% (a delaminated hectorite, higher Ca), and Bentone OC at 15% (a delaminated hectorite, higher Ca). The bentonites and the hectorite at 10% were tested at 100, 150 and 200 mg/L while the hectorite at 15% was tested at 100 mg/L. Mix times were all set at 60 seconds and settling times were set at 1 minute. A control of 1.5 mg/L NaOH (50%) was again included. The bentonites and hectorites all contained 113 mg/L of NaOH (50%) and had a pH of 4.4. In addition, 10 mg/L of Superfloc 1598 was added to each of the bentonite and hectorite samples.

Turbidity results found that Bentolite 865 at 20% and 200 mg/L provided the lowest turbidity of 27 FAU, with Bentolite 865 at 20% and 150 mg/L at 34 FAU. The Bentolite 865 at 15% and 200 mg/L provided a turbidity of 41 FAU, while Bentone OC at 10% and 200 mg/L showed turbidity of 75 FAU all compared with the control turbidity of 403 FAU.

The results shown in Table 2 also reveal that the clay needs to be delaminated in a concentration exceeding 15% and preferably about 20%. In particular, the 20% Bentolite 865 provided significantly lower turbidities than those for the 15% Bentolite 865 material. In addition, the other hectorites evaluated (i.e. Bentone OC) did not provide the low turbidities achieved by the delaminated Bentolite 865.

Table 3 includes further evaluation results of a comparison between delaminated Bentolite 865 and non-delaminated Bentolite 865. Each sample was tested in concentrations of 400, 500, 600, 700 and 800 mg/L. Mix times were again set at 60 seconds, and settling times at 1 minute. A control of 1.5 mg/L NaOH (50%) was included. All of the samples contained 38 mg/L of NaOH (50%) and had a pH of 5.5. Further, 10 mg/L of Superfloc 1598, and 5 mg/L of Superfloc 4814 were added to each of the samples.

The results shown in Table 3 show that the clearest solution (i.e. lowest turbidity) was the delaminated Bentolite 865 at 500 mg/L having a turbidity of 15 FAU, with the delaminated Bentolite 865 at 600 mg/L having turbidity of 18 FAU, delaminated Bentolite 865 at 700 mg/L having turbidity of 35 FAU, and delaminated Bentolite 865 at 800 mg/L having turbidity of 50 FAU. The control and all of the non-delaminated samples exhibited turbidity greater than 1100 FAU.

The results of the evaluations shown in Table 1 and Table 2 show that the most cost effective clay tested is the high swelling bentonite (Bentolite 865). The results from Table 3 show that significant benefits are derived from the use of delaminated bentonites and hectorites. These evaluations confirm the superior performance of the sodium ion exchanged bentonites. It is also seen that the operating pH window of the coagulant nanoparticles of the present invention is different from that of conventional coagulant chemistry. This is not surprising since the zeta potential of the nanoparticles of the present invention would be negative while the conventional coagulants (e.g. polymeric aluminum based coagulants) have a cationic (positive) charge. The cationic surfactants which are one component of the wastewater have a higher cationic charge at acid pH and therefore are more effectively adsorbed and coagulated by the anionic nanoparticles of the present invention. Conventional coagulants work more effectively when the wastewater charge increases in negativity, i.e., the surfactants assume a more negative charge and are coagulated by the positively charged cationic aluminum coagulant.

Delamination of the bentonite particles is essential in the present invention in order for the cationic contaminants to be adsorbed and bridge gaps between the clay particles. The coagulant nanoparticles of the present invention are effective in animal slaughtering houses because the proteins from the blood have a cationic charge at low pH and are therefore effectively adsorbed onto the nanoparticles and coagulated.

There is additional potential for the use of polymeric nanoparticles and polymeric nanospheres (1-50 nm) that can be designed with various surface chemistries and then blended to provide a wide range of coagulant surface chemistries for contaminant removal. Alternatively, nanocapsules having specific chemistries can be made that can be used to remove specific contaminants.

By using coagulant nanotechnology of the present invention, the scope and performance of physical primary treatment is greatly enhanced and the need for secondary biological treatment may be greatly reduced or eliminated. This is particularly true for certain technologies, e.g. protein recovery in kill facilities, metal recovery in plating wastes.

Synergies between conventional coagulants and the nanocoagulants of the present invention provide significant opportunities for the removal of a broad spectrum of contaminates, because the chemistries have a different operating mechanism.

Multi-Angle Laser Light Scattering (MALLS) particle sizing of the delaminated clays according to the present invention does not illustrate that they are nanoparticles. Rather the average delaminated clay particle size is approximately 3.0 microns as compared to 3.5 microns for the non-delaminated clay. This is because the non-delaminated clay is made up of layers having a “rod” or elongated sandwich shape. These rods may have a length of about 3.0 microns long with an end 1000 nm wide. Delamination breaks the layers apart but results in particles maintaining the length of about 3.0 microns long but having ends of 100-500 nm wide. It is on these ends that the contaminants are adsorbed. While it could be argued that the zeta potential on the rod ends is positive because the exchangeable cation is exposed, the fact that the nanoparticles are effective in protein applications where the charge of the contaminant, i.e. poultry, beef, pork, etc. blood, is positive would suggest that the nanoparticles are anionic in nature. The performance of the delaminated clay chemistry can be improved by synthesizing a clay having optimum nanoparticle diameters instead of the less effective rod shape. Such optimum nanoparticle diameter is generally equivalent to the diameter of the end of the rod.

The present invention also includes processes for recovering spent coagulants and recycling them. The recovery process may be accomplished through any of a number of known techniques, including desorption.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

TABLE 1

| | | Test Group | | | | | | | | | | |
|---|---|---|---|---|---|---|---|---|---|---|---|---|
| | | Blank/control | | | | | | | | | | |
| Test # | Units | SG | A | A | A | B | B | B | C | C | C | D |
| Mix Time | Secs | | 60 | 60 | 60 | 60 | 60 | 60 | 60 | 60 | 60 | 60 |
| Settling Time | Mins | | 1 | 1 | 1 | 1 | 1 | 1 | 1 | 1 | 1 | 1 |
| NaOH (50%) | mg/L | 1.5 | 113 | 113 | 113 | 113 | 113 | 113 | 113 | 113 | 113 | 113 |
| pH | | | 4.4 | 4.4 | 4.4 | 4.4 | 4.4 | 4.4 | 4.4 | 4.4 | 4.4 | 4.4 |
| Bentolite 865 | mg/L | | 100 | 150 | 200 | | | | | | | |
| 20% | | | | | | | | | | | | |
| Bentolite L10 | mg/L | | | | | 100 | 150 | 200 | | | | |
| EA3002 | mg/L | | | | | | | | 100 | 150 | 200 | |
| Particlear | mg/L | | | | | | | | | | | 150 |
| Superfloc | mg/L | | 10 | 10 | 10 | 10 | 10 | 10 | 10 | 10 | 10 | 10 |
| 1598 | | | | | | | | | | | | |
| Turbidity | FAU | 403 | 130 | 34 | 27 | ND | ND | 217 | 36 | 27 | 4 | 174 |
| Total COD | ppm | 4300 | 3960 | 3630 | 3420 | | | | 3760 | 3720 | 3790 | 4090 |
| Soluble COD | ppm | 4710 | 3850 | 3740 | 3720 | | | | 3730 | 3700 | 3690 | 3690 |
| TSS | ppm | 194 | 120 | 76 | 80 | | | | 48 | 44 | 52 | 104 |

TABLE 2

| | | Test Group | | | | | | | | | | |
|---|---|---|---|---|---|---|---|---|---|---|---|---|
| | | Blank/control | | | | | | | | | | |
| Test # | Units | SG | A | A | A | B | B | B | C | C | C | D |
| Mix Time | Secs | | 60 | 60 | 60 | 60 | 60 | 60 | 60 | 60 | 60 | 60 |
| Settling Time | Mins | | 1 | 1 | 1 | 1 | 1 | 1 | 1 | 1 | 1 | 1 |
| NaOH (50%) | mg/L | 1.5 | 113 | 113 | 113 | 113 | 113 | 113 | 113 | 113 | 113 | 113 |
| pH | | | 4.4 | 4.4 | 4.4 | 4.4 | 4.4 | 4.4 | 4.4 | 4.4 | 4.4 | 4.4 |
| Bentolite 865 | mg/L | | 100 | 150 | 200 | | | | | | | |
| 15% | | | | | | | | | | | | |
| Bentolite 865 | mg/L | | | | | 100 | 150 | 200 | | | | |
| 20% | | | | | | | | | | | | |
| Bentone OC | mg/L | | | | | | | | 100 | 150 | 200 | |
| 10% | | | | | | | | | | | | |
| Bentone OC | mg/L | | | | | | | | | | | 100 |
| 15% | | | | | | | | | | | | |
| Superfloc | mg/L | | 10 | 10 | 10 | 10 | 10 | 10 | 10 | 10 | 10 | 10 |
| 1598 | | | | | | | | | | | | |
| Turbidity | FAU | 403 | >200 | >200 | 41 | 130 | 34 | 27 | 109 | 92 | 75 | 109 |

TABLE 3

| | | Test Group | | | | | | | | | | |
|---|---|---|---|---|---|---|---|---|---|---|---|---|
| | | Blank/control | | | | | | | | | | |
| Test # | Units | SG | A | A | A | A | A | B | B | B | B | B |
| Mix Time | Secs | | 60 | 60 | 60 | 60 | 60 | 60 | 60 | 60 | 60 | 60 |
| Settling Time | Mins | | 1 | 1 | 1 | 1 | 1 | 1 | 1 | 1 | 1 | 1 |
| NaOH (50%) | mg/L | 1.5 | 38 | 38 | 38 | 38 | 38 | 38 | 38 | 38 | 38 | 38 |
| pH | | | 5.5 | 5.5 | 5.5 | 5.5 | 5.5 | 5.5 | 5.5 | 5.5 | 5.5 | 5.5 |
| Bentolite 865 | mg/L | | 400 | 500 | 600 | 700 | 800 | | | | | |
| delaminated | | | | | | | | | | | | |
| Bentolite 865 | mg/L | | | | | | | 400 | 500 | 600 | 700 | 800 |
| non- | | | | | | | | | | | | |
| delaminated | | | | | | | | | | | | |
| Superfloc | mg/L | | 10 | 10 | 10 | 10 | 10 | 10 | 10 | 10 | 10 | 10 |
| 1598 | | | | | | | | | | | | |
| Superfloc | mg/L | | 5 | 5 | 5 | 5 | 5 | 5 | 5 | 5 | 5 | 5 |
| 4814 | | | | | | | | | | | | |
| Turbidity | FAU | >1100 | >200 | 15 | 18 | 35 | 50 | >1100 | >1100 | >1100 | >1100 | >1100 |

What is claimed is:

1. A coagulant for use in wastewater treatment comprising an anionic nanoparticulate clay.

2. A coagulant according to claim 1 wherein the clay is a bentonite clay.

3. A coagulant according to claim 1 wherein the clay is a hectorite clay.

4. A coagulant according to claim 1 wherein the clay is a delaminated clay.

5. A coagulant according to claim 1 further comprising a cationic or amphoteric coagulant material.

6. A method for treating wastewater comprising incorporating an anionic delaminated nanoparticulate clay into the wastewater; absorbing contaminates onto surfaces of the nanoparticulate clay to form a pin floc; adding a flocculating agent to the wastewater to fully flocculate the contaminates; and removing the contaminates from the wastewater.

7. A method according to claim 6 further comprising removing the contaminates from the nanoparticulate clay and recycling the nanoparticulate clay for further use.

8. A method according to claim 7 wherein the clay is a bentonite clay.

9. A method according to claim 7 wherein the clay is a hectorite clay.

10. A method according to claim 7 wherein the clay is mixed with cationic or amphoteric coagulant material.

11. A method according to claim 7 wherein the wastewater is wastewater from a food processing plant.
